(19) United States
(12) Patent Application Publication
(10) Pub. No.: US 2019/0005086 A1
(43) Pub. Date: Jan. 3, 2019

(54) SYSTEM AND METHOD FOR SYSTEM FOR DETERMINING DATABASE RELATIONS BASED ON DATA MONITORING

(71) Applicant: Equalum Ltd., Tel-Aviv (IL)

(72) Inventor: Ofir MANOR, Tel Aviv (IL)

(73) Assignee: Equalum Ltd., Tel-Aviv (IL)

(21) Appl. No.: 16/025,153

(22) Filed: Jul. 2, 2018

Related U.S. Application Data
(60) Provisional application No. 62/528,112, filed on Jul. 2, 2017.

(51) Int. Cl. G06F 17/30

(52) U.S. Cl. CPC G06F 17/30371; G06F 17/30377; G06F 17/30477; G06F 17/30604

(57) ABSTRACT

A system and method for determining database relations. The method includes: receiving at least a portion of a transaction log, the transaction log comprising a plurality of data records detailing changes of at least a first table and a second table of a target system; and generating a probability regarding a relation between the first table and the second table within the target system, based on the at least a portion of the transaction log. In an embodiment, the method further includes: sending a query to target system, wherein the query includes instructions related to data within at least one table stored within the target system, wherein the changes of at least the first table and the second table of a target system are related to the query.

### CROSS-REFERENCE TO RELATED APPLICATIONS

This application claims the benefit of U.S. Provisional Application No. 62/528,112 filed on Jul. 2, 2017, the contents of which are hereby incorporated by reference.

### TECHNICAL FIELD

The present disclosure relates generally to relational databases, and particularly to the reproduction of systems of relational databases.

### BACKGROUND

Relational databases store data that is stored in tabular form, which includes multiple rows and columns of data. Each row, or tuple, contains a unique data entry, while each column includes a data category further qualifying each data entry. The relational database allows users to create connections and links among different data records, and to use those connections and links to view and manage the data.

Legacy data systems may encounter various problems when attempting to replace data elements, add new data elements which need to communicate with old data elements, update data elements, and the like. A data element may be included in a data warehouse, a relational database, and the like. When attempting to replace or link new data elements to an older data system, it may be found that the relations of the database columns are unknown. It would therefore be useful to know, for example, how tables relate to each other within one or more databases. Establishing relations between data elements allows for increased efficiency in finding, analyzing, and handling data.

It would therefore be advantageous to provide a solution that would overcome the technical challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for determining database relations, where the method includes: receiving at least a portion of a transaction log, the transaction log comprising a plurality of data records detailing changes of at least a first table and a second table of a target system; and generating a probability regarding a relation between the first table and the second table within the target system, based on the at least a portion of the transaction log.

Certain embodiments disclosed herein also include a non-transitory computer readable medium having stored thereon instructions for causing a processing circuitry to perform a process, where the process includes: receiving at least a portion of a transaction log, the transaction log comprising a plurality of data records detailing changes of at least a first table and a second table of a target system; and generating a probability regarding a relation between the first table and the second table within the target system, based on the at least a portion of the transaction log.

Certain embodiments disclosed herein also include a system for determining database relations, where the system includes: a processing circuitry; and a memory, the memory containing instructions that, when executed by the processing circuitry, configure the system to: receive at least a portion of a transaction log, the transaction log comprising a plurality of data records detailing changes of at least a first table and a second table of a target system; and generate a probability regarding a relation between the first table and the second table within the target system, based on the at least a portion of the transaction log.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a reproduction server according to an embodiment.

FIG. 2 is a schematic diagram of a reproduction server communicatively connected over a network to a monitored target system according to an embodiment.

FIG. 3 is a schematic diagram of a user terminal sending an instruction to a monitored target system according to an embodiment.

FIGS. 4A and 4B are schematic drawings of a user terminal sending an instruction to a monitored target system for generating a resulting solution, and of a plurality of databases and tables receiving the exemplary instructions of FIG. 4A, respectively, according to an embodiment.

FIG. 5 is a flowchart of a computerized method for reproducing a relational database structure, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Many legacy systems encounter difficulties with updating or replacing elements (e.g., databases, data warehouses) as certain data relations are unknown within the system. The present disclosure includes methods for reconstructing a relational database structure, thereby providing an advantageous technical solution. A target system includes a database, a plurality of tables, and a transaction log that is connected to a monitoring agent. Each transaction in the log details updating a table, and at least one transaction details updating a first table and a second table. A probability is determined that a first table is related to a second table, and a report of probabilities based on the determination may be generated. The monitoring agent may continuously send transactions from the log to a reconstruction server, and probabilities may be determined continuously. In certain embodiments, a probability that a first column from a first database and a first column from a second database are related may be determined, wherein if the probability is above a predetermined threshold, it is determined that the data elements from the first table and the second table are related.

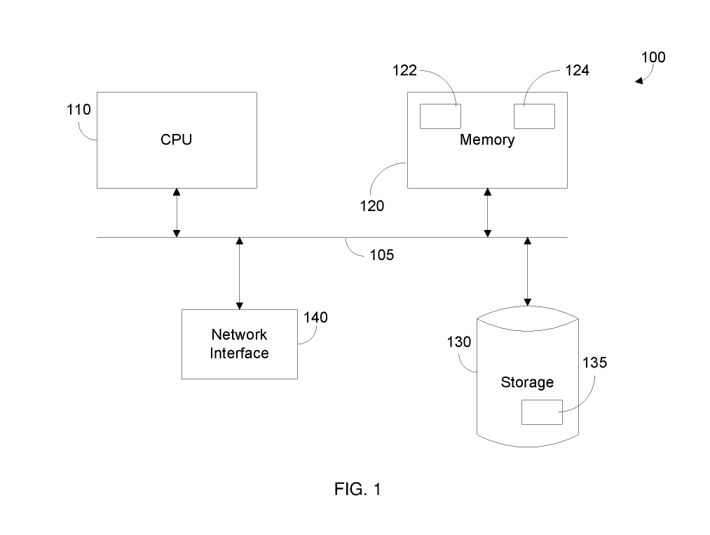

FIG. 1 is an exemplary and non-limiting schematic diagram of a reproduction server 100 implemented according to an embodiment. The system 100 includes at least one processing circuitry 110, such as a central processing unit (CPU). In an embodiment, the processing circuitry 110 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing circuitry 110 is coupled via a bus 105 to a memory 120. The memory 120 may include a memory portion 122 that contains instructions that, when executed by the processing circuitry 110, perform or cause the performance of the method described in more detail herein. The memory 120 may be further used as a working scratch pad for the processing circuitry 110, a temporary storage, and others, as the case may be. The memory 120 may be a volatile memory such as, but not limited to, random access memory (RAM), or non-volatile memory (NVM), such as, but not limited to, flash memory. The processing circuitry 110 may be further coupled with a storage 130. The storage 130 may be used for the purpose of holding a copy of the instructions executed in accordance with the disclosed technique. The storage 130 may include a storage portion 135 containing at least a portion of a transaction log from a monitored system. The processing circuitry 110 may be further coupled to a network interface 140. The network interface may include a network interface controller (NIC) (not shown) for communicating over a network with a software module configured to detect changes in a monitored system. The processing circuitry 110 and/or the memory 120 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processing circuitries, cause the system to perform the various functions described in further detail herein.

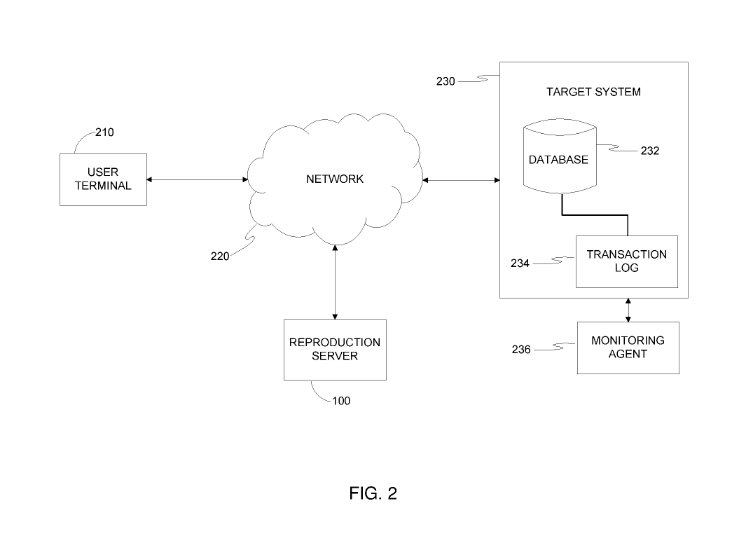

FIG. 2 is an exemplary and non-limiting schematic diagram of a reproduction server 100 connected over a network 220 to a monitored target system 230 according to an embodiment. In an embodiment, the network 220 may be configured to provide connectivity of various sorts, as may be necessary, including but not limited to, wired and/or wireless connectivity, including, for example, local area network (LAN), wide area network (WAN), metro area network (MAN), worldwide web (WWW), the Internet, and any combination thereof, as well as cellular connectivity. The network 220 is further connected to a user terminal 210, and a monitored target system 230. The target system 230 includes a database 232, and a transaction log 234. The transaction log 234 includes a log of one or more changes made to the database. The transaction log 234 may be monitored by a monitoring agent 236 configured to detect changes made to the database 232. In some embodiments, the target system 230 may include one or more databases. In an embodiment, the monitoring agent 236 may be installed on the target system 230. In certain embodiments, the monitoring agent 236 may be installed on any machine configured to communicate with the target system 230. The database 232 includes a plurality of fields. Upon receiving a query or instruction from the user terminal 210, the database 232 may be updated with data received from the query or instructions. For example, if the database 232 contains information regarding employees of a corporation, the target system 230 may receive an instruction to update the database 232 with details of a new employee. The instruction may include one or more field names, and a value, such as an alphanumerical value, to be inserted into the field. A field name in this example may be “first name,” “family name,” “employee id,” “department,” and the like. In some examples, the order in which the data is received may correspond to the field name, e.g., the first value corresponds to the “family name” column in the database, the third value corresponds to the “employee id” column, etc. The transaction log 234 may include each change which is performed in the databases 232, corresponding to an instruction received from the user terminal 210. In certain embodiments, a single instruction executed by the target system 230 may cause a plurality of fields in a plurality of databases to be updated. It may be advantageous to reproduce the relations between fields within a database or between databases. Understanding such relations allow for improving performance of the target system 230, as well as upgrading the target system 230 to include improved hardware or software, as explained herein below.

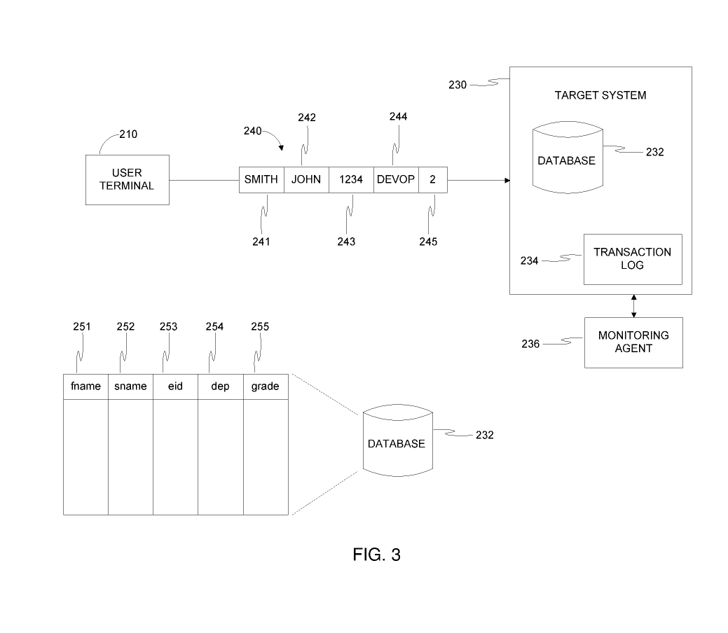

FIG. 3 is a schematic diagram of a user terminal 210 sending an instruction to a monitored target system 230 according to an embodiment. The user terminal 210 sends an instruction 240 to a monitored target system 230, where the instruction 240 includes a plurality of data values 241, 241, 243, 244, and 245, each corresponding to a column in a table of database 232. A first data value 241 corresponds to a column ‘fname’ 251, which is a family name. A second value 242 corresponds to a column ‘sname’ 252, which is a surname. A third value 243 corresponds to a column ‘eid’ 253, which is an employee identification number. A fourth value 244 corresponds to a column ‘dep’ 254, which is a department name. A fifth value 245 corresponds to a column ‘grade’ 255, which is a salary grade. In this example, ‘grade’ has a value of 2. The database may include another table corresponding a grade level to a currency value of a salary. For example, grade level 2 may be associated with an annual salary of $60,000.

In an embodiment, the user terminal 210 includes a user interface (not shown) through which a user may input the one or more data values. The user terminal 210 may generate the instruction 240 based on the received data values. In some embodiments, the reproduction server 100 may generate the instruction 240 and receive information monitored by the monitoring agent 236 to correlate the data values to changes affected in the one or more tables of the database. In certain embodiments, the reproduction server 100 may receive the instruction 240 from the user terminal 210.

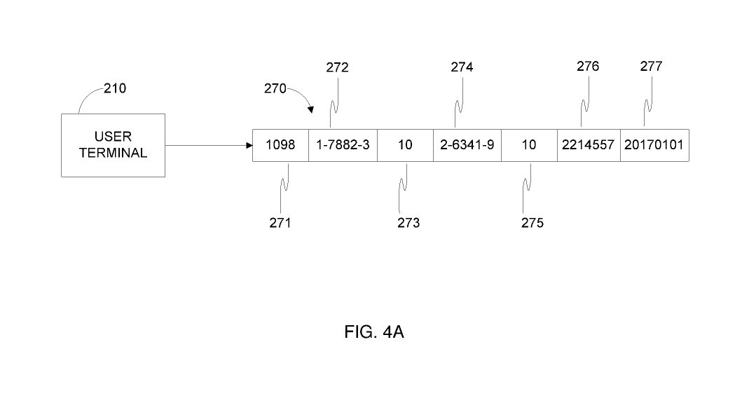

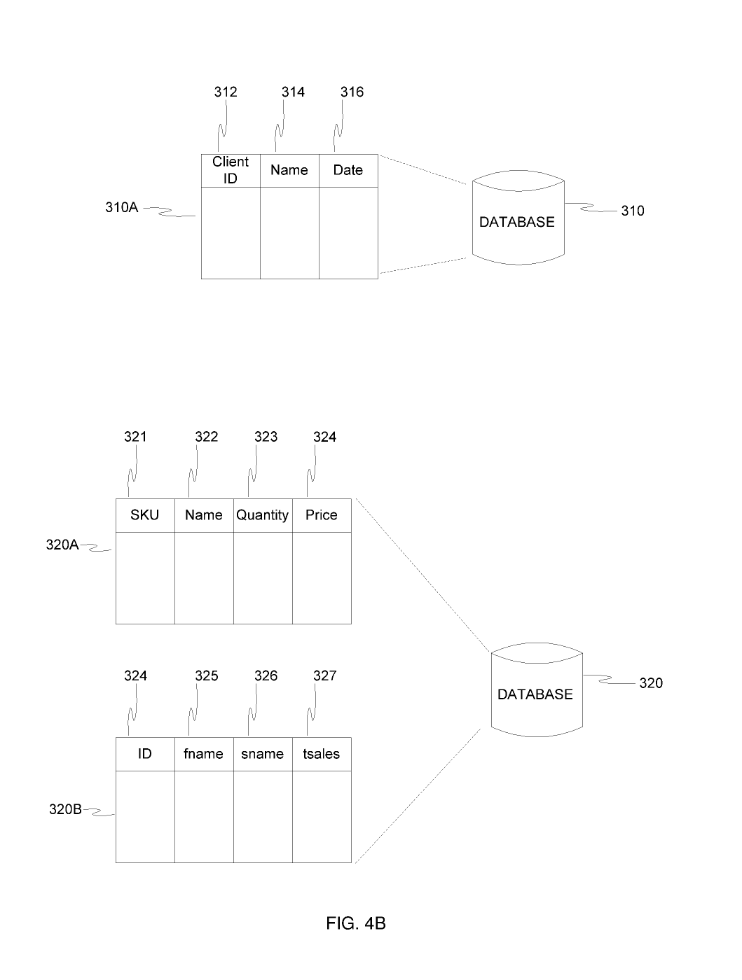

FIG. 4A is a schematic diagram of a user terminal 210 sending an exemplary instruction 270 to a monitored target system. FIG. 4B is a schematic illustration of a plurality of databases and tables receiving the exemplary instructions 270 of FIG. 4A. In this embodiment, the instruction 270 is directed towards a plurality of tables, each implemented on a different database. It should be readily understood that any combination of tables implemented on any of one or more databases may be utilized in different embodiments.

The user terminal 210 sends an instruction 270, which includes a plurality of data values. The instruction 270 may include a plurality of instructions, each having one or more values. In an embodiment, a first data value 271 corresponds to a column labeled ‘Client ID’ 312 of a first table 310A stored in a database 310. The table further includes a column labeled ‘name’ 314, which corresponds to a client name. The second data value 272 corresponds to a column labeled ‘SKU’ 321, of a second table 320A stored in database 320. The second table 320A further includes a column labeled ‘Name’ 322, which corresponds to a product name of the SKU, a column labeled ‘Quantity’ 323, which corresponds to the quantity of the product in an inventory, and a column labeled ‘Price’ 324, which corresponds to a price per unit. A third value 273 of the instruction 270 corresponds to a number of units being ordered corresponding to SKU value 272. A fourth value 274 also corresponds to the column labeled ‘SKU’ 321, and is a second SKU value. The fifth value 275 corresponds to a number of units being ordered of the second SKU value 274. The sixth value 276 corresponds to a column labeled ‘id’ 324, which is an employee identification number, indicating the employee which initiated the purchase order on behalf of the client.

The column labeled ‘id’ 324 is part of a second table 320B stored on the second database 320. The seventh value 277 corresponds to column labeled ‘date’ 316 of first table 310A, which is a timestamp indicating when the purchase order is made. The second table 320A further includes a column labeled ‘fname’ 325 which corresponds to a first name, a column labeled ‘sname’ 326 which corresponds to a surname of an employee with the respective employee id number, and a column labeled ‘tsales’ 327 which corresponds to the total sales made by the employee.

A fourth table may be utilized to store therein the details of the purchase order, by querying one or more of the previous tables to include the additional data therefrom. For example, the employee ID number may be used to include the name of the employee who initiated the purchase order. The first table 320A may be used to include the name of the relevant SKUs, and the quantity field may be updated based on the number of units requested by the purchase order. A transaction log, such as transaction log 234, records the changes made to one or more tables of the databases 310 and 320. By monitoring the transaction log, it is possible to reproduce the relation between fields of one or more tables, e.g., 310A, 320A and 320B, and associate the relation with an event originating from the user terminal 210. An a non-limiting example, if a first field from a first database is updated every time a second field from a second database is updated, it may be determined that the first field is directly correlated to the second field. In some embodiments, multiple databases, each having a plurality of data elements are monitored, and a statistical model is implemented to determine relations between various data elements, or various databases.

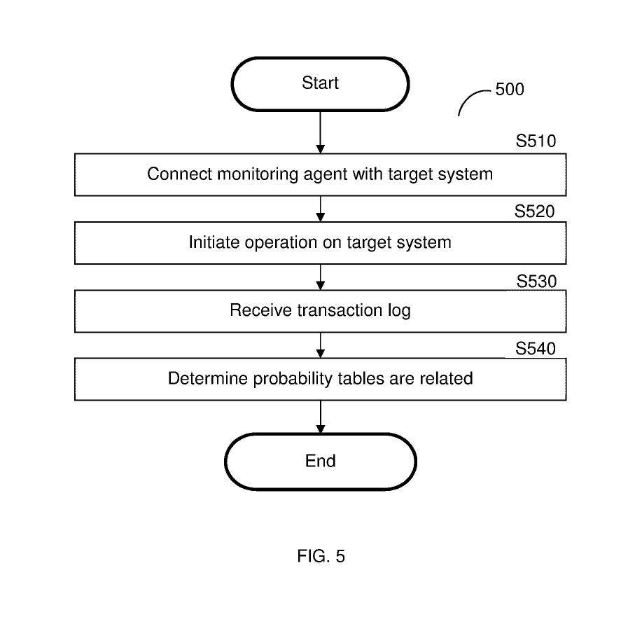

FIG. 5 is a flowchart of a method 500 for reproducing a relational database structure according to an embodiment.

At S510, a monitoring agent is communicatively coupled to a target system. The monitoring agent may be, for example, installed on a reproduction server, on the target system, or any other machine communicatively connected to the target system. In some embodiments, one or more monitoring agents may monitor one or more target systems. In an embodiment, the monitoring agent monitors and records changes made to a table of a database. Monitoring may be performed by detecting changes, such as input/output operations directed to a storage of a storage device of the target system, or detecting changes in a transaction log of a database of the target system, for example.

At S520, an operation is initiated for the target system. The operation may be initiated by a user device, and/or the reproduction server. In some embodiments the operation may be a test, or benchmark, or an operation. A test operation may include sending the target system a query with distinct data values. Using distinct data values allows for more efficient searching for data values in the transaction log of the target system. However, normal operations may be used as well. In some embodiments, a plurality of operations may be initiated. The plurality of operations may include a pair of identical operations, which can be used to ensure that the target system responds identically to identical operations.

At S530, the monitoring agent sends at least a portion of the transaction log of the target system to the reproduction server. In some embodiments, the target system may include a plurality of transaction logs, and the monitoring agent may send one or more portions of any of the transaction logs. A transaction log details what changes or updates have been made to a table of a database, by which user and/or node, at what time, what the change/update was, and the like.

At S540, a probability is generated that a first table and a second table are related, based on the sent portions of the transaction logs. The probability may be generated, for example, by determining the number of times a first table and a second table appear together. Appearing together in this context may mean, for example, the number of transactions in which both the first table and the second table are updated. In some embodiments, if the probability is above (or below) a predefined threshold, an alert may be sent, for example to either a user device or user account. In some cases, a first table may have a higher probability to be related to a second table, than the probability of the second table to be related to the first table. This may mean, for example, that each time the first table is updated, the second table is updated; however, the second table may be updated without updating the first table. In some embodiments, a report may be generated (for example periodically) to list combinations of tables and the probability they are related. In certain embodiments, the probability may be generated for a plurality of tables greater than two (e.g., the probability that three, four, etc. tables are related).

In an exemplary embodiment, a user terminal 210 sends a target system a new purchase order. The purchase order includes instructions which appear in a transaction log 234 of a target system 230. For example, a first transaction includes an instruction to update the table 310A of database 310. Specifically, the instruction may be to update the ‘Date’ column 316 with a timestamp value 277. The first transaction may further include an instruction to update the ‘Quantity’ column 323 of table 320A to subtract the quantity of units being ordered of the relevant SKUs. The first transaction may further also include an instruction to update table column ‘tsales’ 327 of table 320B with the sale number of the purchase order. This instruction may have sub-instructions to determine the sale number based on the number of SKUs and price per each, in order to generate the sale number of the purchase order. A second transaction may include an instruction to update table 320A with a new SKU, a product name, and the number of units, corresponding to columns 321, 322, and 323 of table 320A. In this exemplary embodiment, with only two transactions (presented for simplicity's sake), table 310A is updated 100% of the time together with tables 320A and 320B. Likewise, table 320B is updated 100% of the time together with table 320A and 310A. However, table 320A is only updated 50% of the time together table 320B or table 310A. In a more general method, statistical models may be used to establish the threshold of probability. For example, if table 310A appears 100 times out of 1000 transactions (10%), and table 320A appears 50 times out of 1000 transactions (5%)—if they are not correlated (i.e., independent of each other), their expected probability is to appear together in 5 transactions out of 1000 (0.5%). However, if they are correlated, that probability is greater. A determination is made of the probability P(A|B) (i.e., the probability of table 310A to occur in a transaction once table 320A occurred), and P(B|A), which is the probability of table 320A to occur once table 310A occurred in a transaction.

While the above examples discuss statistical probabilities that tables are related, they may be applied likewise to determining relations between columns and/or rows of the same (or different) tables, without departing from the scope of this disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining database relations, comprising:
receiving at least a portion of a transaction log, the transaction log comprising a plurality of data records detailing changes of at least a first table and a second table of a target system; and
generating a probability regarding a relation between the first table and the second table within the target system, based on the at least a portion of the transaction log.

2. The method of claim 1, further comprising:
sending a query to target system, wherein the query includes instructions related to data within at least one table stored within the target system, wherein the changes of at least the first table and the second table of a target system are related to the query.

3. The method of claim 2, wherein the changes related to the query include operations directed to a database of the target system.

4. The method of claim 1, wherein the probability indicates a correlation between the first table and the second table within the target system.

5. The method of claim 4, wherein the probability of the first table being correlated to the second table is not the same as the probability of the second table being correlated to the first table.

6. The method of claim 1, wherein the probability is generated based on the frequency the first table and the second table appear together within the target system.

7. The method of claim 6, wherein the probability is generated based on the number of operations in which both the first table and the second table are updated based on a query.

8. The method of claim 1, further comprising:
determining if the probability value is above or below a predefined threshold.

9. The method of claim 8, further comprising:
sending an alert to a user if the probability value is above or below the predefined threshold.

10. The method of claim 1, further comprising:
generating a report including a list of tables and the probability the list of tables are correlated.

11. A non-transitory computer readable medium having stored thereon instructions for causing a processing circuitry to perform a process, the process comprising:
receiving at least a portion of a transaction log, the transaction log comprising a plurality of data records detailing changes of at least a first table and a second table of a target system; and
generating a probability regarding a relation between the first table and the second table within the target system, based on the at least a portion of the transaction log.

12. A system for determining database relations, comprising:
a processing circuitry; and
a memory, the memory containing instructions that, when executed by the processing circuitry, configure the system to:
receive at least a portion of a transaction log, the transaction log comprising a plurality of data records detailing changes of at least a first table and a second table of a target system; and
generate a probability regarding a relation between the first table and the second table within the target system, based on the at least a portion of the transaction log.

13. The system of claim 12, the system further configured to:
send a query to target system, wherein the query includes instructions related to data within at least one table stored within the target system, wherein the changes of at least the first table and the second table of a target system are related to the query.

14. The system of claim 13, wherein the changes related to the query include operations directed to a database of the target system.

15. The system of claim 12, wherein the probability indicates a correlation between the first table and the second table within the target system.

16. The system of claim 15, wherein the probability of the first table being correlated to the second table is not the same as the probability of the second table being correlated to the first table.

17. The system of claim 12, wherein the probability is generated based on the frequency the first table and the second table appear together within the target system.

18. The system of claim 17, wherein the probability is generated based on the number of operations in which both the first table and the second table are updated based on a query.

19. The system of claim 12, the system further configured to:
determine if the probability value is above or below a predefined threshold.

20. The system of claim 19, the system further configured to:
send an alert to a user if the probability value is above or below the predefined threshold.

21. The system of claim 12, the system further configured to:
generate a report including a list of tables and the probability the list of tables are correlated.
